(19) United States
(12) Patent Application Publication
(10) Pub. No.: US 2020/0344618 A1
(43) Pub. Date: Oct. 29, 2020

(54) BLUETOOTH PACKET TRANSMIT OPTIMIZATION WITH SIMULTANEOUS CHANNEL SENSING

(71) Applicant: Avago Technologies International Sales Pte. Limited, Singapore (SG)

(72) Inventors: Harish SHETIYA, Bangalore (IN); Amrit Swarup Devulapalli, Bangalore (IN); Ravi Nagarajan, Bangalore (IN); Kartikeya Mehrotra, Bangalore (IN)

(21) Appl. No.: 16/396,517

(22) Filed: Apr. 26, 2019

(51) Int. Cl. H04W 24/02

(52) U.S. Cl. CPC H04W 24/02; H04W 84/12

(57) ABSTRACT

A device implementing the Bluetooth packet transmit optimization with simultaneous channel sensing may include at least one processor configured to transmit a first packet over a first channel in a first time period; perform channel sensing on a second channel in a second time period subsequent to the first time period; apply a remedial action to a transmission of a second packet based on the channel sensing; and transmit the second packet following the applied remedial action. The subject system utilizes some of the following potential remedial actions, such as 1) deferring transmission of a next Bluetooth frame, 2) increasing the packet transmission power, and/or 3) modifying a transmission packet type or packet length. A method and computer program product implementing the subject Bluetooth packet transmit optimization is also provided.

### TECHNICAL FIELD

The present disclosure relates generally to wireless communication devices, and in particular, to Bluetooth packet transmit optimization with simultaneous channel sensing.

### BACKGROUND

Wireless connectivity in wireless communications, such as Bluetooth, forms the core aspect of handheld Smart Devices (Smartphones, Tablets, etc.). Among them, Bluetooth connectivity has emerged as the most sought after modes for audio streaming and phone calls. With a high number of users sharing the same operating band (e.g., 2.4 GHz ISM band), effective congestion handling becomes very important for improved latency response and lower power consumption. Bluetooth uses Adaptive Frequency Hopping (AFH) technique for increasing immunity towards interference caused by other devices sharing the same operating band.

### BRIEF DESCRIPTION OF THE DRAWINGS

Certain features of the subject technology are set forth in the appended claims. However, for purpose of explanation, one or more implementations of the subject technology are set forth in the following figures.

FIG. 1 is a diagram illustrating wireless communication system in accordance with one or more implementations.

FIG. 2A illustrates a schematic block diagram of a wireless communication portion of a wireless device having a single antenna according to one or more implementations of the subject technology.

FIG. 2B is a diagram illustrating a wireless communication device of a wireless device having multiple antennas according to one or more implementations of the subject technology.

FIG. 3 conceptually illustrates an example of a communication environment according to one or more implementations of the subject technology.

FIG. 4 illustrates an example of a Bluetooth communication system according to one or more implementations of the subject technology.

FIGS. 5A and 5B illustrate examples of a frame exchange between a master device and a slave device according to one or more implementations of the subject technology.

FIGS. 6A-6D illustrate diagrams of frame exchanges between master and slave devices using channel sensing simultaneous with using different remedial actions for packet transmit optimization according to one or more implementations of the subject technology.

FIG. 7 is a flow chart illustrating a process for packet transmit optimization with simultaneous channel sensing in accordance with one or more implementations of the subject technology.

FIG. 8 conceptually illustrates an electronic system with which any implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced using one or more implementations. In one or more instances, structures and components are shown in block diagram form in order to avoid obscuring the concepts of the subject technology.

The AFH technique provides a static assessment of various operating channels. This is not suited for adapting to dynamic changes to channel conditions, e.g., high interference in current channel due to transmission (TX) collision. This disclosure defines a mechanism to sense channel congestion in real time and subsequently take appropriate remedial action during packet transmission, in order to improve the probability of success.

The subject technology is well suited for implementation with a low power dedicated HW core for channel sensing simultaneously with current packet reception. The subject technology reduces average number of retransmissions required for successfully transmitting a packet, which provides several advantages including, among others, 1) enables efficient medium usage, 2) lowers power consumption for transmission of a packet, and 3) lowers average packet TX latency.

In one or more implementations, the subject technology provides for a device implementing the Bluetooth packet transmit optimization with simultaneous channel sensing that may include at least one processor configured to transmit a first packet over a first channel in a first time period; perform channel sensing on a second channel in a second time period; obtain signal strength measurements from the channel sensing of the second channel; determine whether the signal strength measurements satisfy a predetermined threshold; select at least one remedial action of a plurality of remedial actions when the signal strength measurements do not satisfy the predetermined threshold; apply the at least one remedial action to a second packet, the at least one remedial action modifying one or more properties of a transmission of the second packet; and transmit the second packet to a second device, following the applied at least one remedial action.

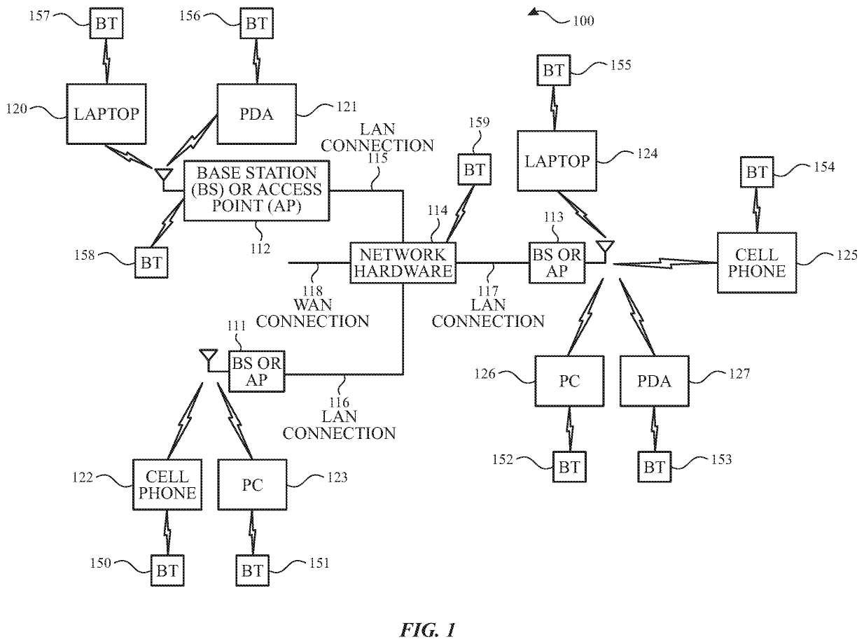

FIG. 1 is a diagram illustrating wireless communication system 100 in accordance with one or more implementations. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

The wireless communication system 100 includes base stations (BS) and/or access points (AP) 111-113 (an AP may be a personal control point), wireless communication devices 120-127 and a network hardware component 114. The wireless communication devices 120-127 include laptop computers 120 and 124, personal digital assistants 121 and 127, personal computers 123 and 126, cellular telephones 122 and 125, and/or any other type of device that supports wireless communications.

The base stations or access points 111-113 are operably coupled to network hardware 114 via respective local area network (LAN) connections 115-117. Network hardware 114, which may be a router, switch, bridge, modem, system controller, may provide a wide area network (WAN) connection 118 for the wireless communication system 100. Base stations or access points 111-113 have an associated antenna or antenna array to individually communicate with wireless communication devices in its area. The wireless communication devices register with a particular base station or access point 111-113 to receive services within the wireless communication system 100. For direct connections (e.g., point-to-point communications), the wireless communication devices may communicate directly via an allocated channel.

Base stations can be used for cellular telephone systems (including LTE and 5G systems) and like-type systems, while access points may be used for in-home or in-building wireless networks. Regardless of the particular type of communication system, each wireless communication device may include a built-in radio and/or is coupled to a radio. The radio includes a linear amplifier and/or programmable multi-stage amplifier to enhance performance, reduce costs, reduce size, and/or enhance broadband applications. The radio also may include, or is coupled to, an antenna or an array of antennas having a particular antenna coverage pattern for propagation of outbound radio frequency (RF) signals and/or reception of inbound RF signals.

According to some implementations, base stations are used for cellular telephone systems (e.g., advanced mobile phone services (AMPS), digital AMPS, global system for mobile communications (GSM), code division multiple access (CDMA), local multi-point distribution systems (LMDS), multi-channel-multi-point distribution systems (MMDS), enhanced data rates for GSM evolution (EDGE), general packet radio service (GPRS), high-speed downlink packet access (HSDPA), high-speed uplink packet access (HSDPA and/or variations thereof) and like-type systems, while access points are used for in-home or in-building wireless networks (e.g., IEEE 802.11, Bluetooth, ZigBee, any other type of radio frequency based network protocol and/or variations thereof). Regardless of the particular type of communication system, each wireless communication device includes a built-in radio and/or is coupled to a radio.

One or more of the shown devices may include circuitry and/or software that allows the particular device to communicate using Bluetooth (BT) communication system technology with each other or with proximal BT devices 150-159. The range of communication using BT is shorter than typical wide local area network (WLAN) links. A BT communication link may utilize various versions of a BT specification, including the Bluetooth Core Specification Version 4.0, Volume 6 (Low Energy Controller Volume) that pertains to Bluetooth™ Low Energy (BLE). Although BLE may operate in conjunction with classical BT, BLE does have a functional difference in the application of the protocol for establishing a communication link between two or more BLE compatible devices.

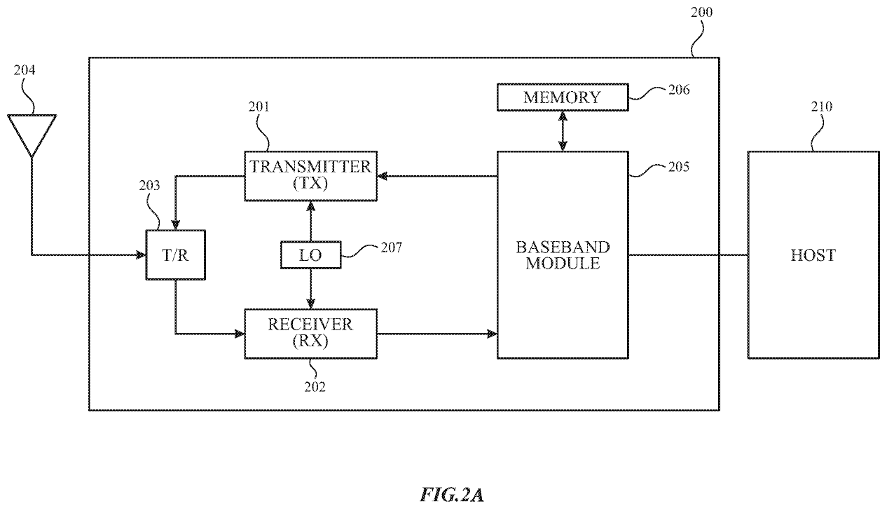

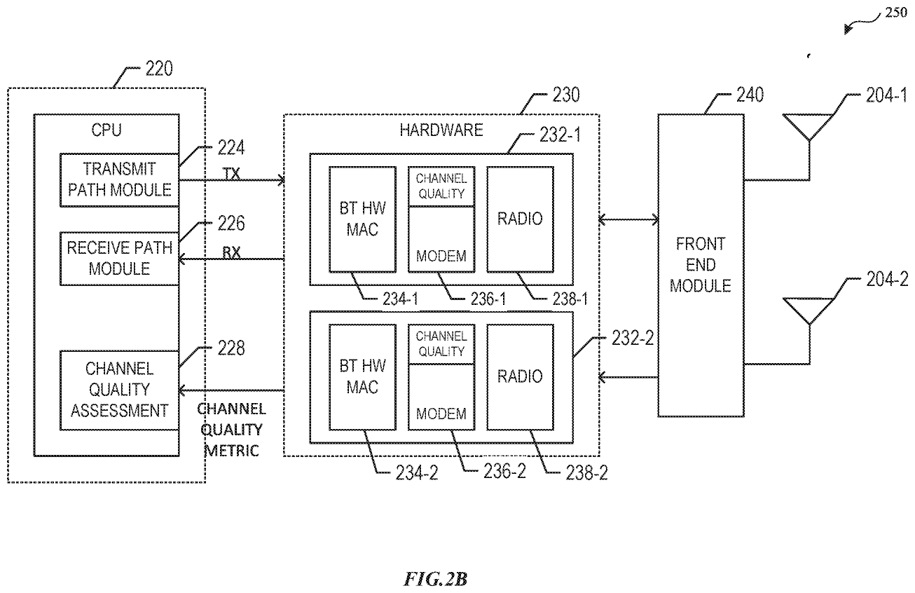

FIG. 2A illustrates a schematic block diagram of a wireless communication portion 200 of a wireless device having a single antenna according to one or more implementations of the subject technology. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

The wireless communication portion 200 includes a transmitter (TX) 201, a receiver (RX) 202, a local oscillator (LO) 207 and a baseband module 205. Baseband module 205 may be configured to provide baseband processing operations. In some implementations, baseband module 205 includes a digital signal processor (DSP). The baseband module 205 is coupled to a host unit (e.g., host 210), an applications processor or other unit(s) that provides Bluetooth operational processing for the device and/or interface with a user.

As shown in FIG. 2A, a host 210 is provided. The host 210 may represent a host module of a Bluetooth device, while the wireless communication portion 200 is utilized to provide the radio (e.g. RF front end) and baseband functions. The radio portion of the wireless communication portion 200 may be implemented to support one or more Bluetooth modes, or may include other wireless systems such as WLAN (e.g. WiFi) and/or cellular or satellite communications. Any or all of the hardware shown in FIG. 2A may be incorporated in one or more of the wireless communication devices shown in FIG. 1.

The memory 206 is coupled to the baseband module 205. The memory 206 may be utilized to store data including program instructions that operate on the baseband module 205. Various types of memory devices may be utilized for memory 206. The memory 206 may be located anywhere within the wireless communication portion 200.

The transmitter 201 and receiver 202 are coupled to an antenna 204 via transmit/receive (T/R) switch module 203. The T/R switch module 203 is configured to switch the antenna 204 between the transmitter and receiver depending on the mode of operation. For frequencies in a gigahertz range (e.g., 2.4 GHz to 5 GHz), omni-directional antennas may provide appropriate coverage for communicating between wireless devices.

Outbound data for transmission from the host 210 is forwarded to the baseband module 205 and converted into baseband signals, and then upconverted for transmission via the transmitter 201. For example, the transmitter 201 converts the baseband signals to outbound radio frequency (RF) signals for transmission from the wireless communication portion 200 via antenna 204. The transmitter 201 may utilize one of a variety of up-conversion or modulation techniques to convert the outbound baseband signals to outbound RF signal. The conversion process is dependent on the particular communication standard or protocol being utilized.

In a similar manner, inbound RF signals are received by the antenna 204 and coupled to the receiver 202. The receiver 202 then converts the inbound RF signals into inbound baseband signals, which are then coupled to baseband module 205. The receiver 202 may utilize one of a variety of down-conversion or demodulation techniques to convert the inbound RF signals into inbound baseband signals. The inbound baseband signals are processed by the baseband module 205 and inbound data is output from baseband module 205 to the host 210. In some implementations, the baseband module 205 may perform channel quality sensing of one or more channels (or frequencies) by obtaining signal strength measurements from the inbound RF signals.

The LO 207 provides local oscillation signals to the transmitter 201 for up-conversion and to the receiver 202 for down-conversion. In some aspects, separate LO signals may be used for the transmitter 201 and the receiver 202. Although a variety of LO circuitry may be used, in some implementations, a phase-locked loop (PLL) is utilized to lock the LO to output a frequency-stable LO signal based on a selected channel frequency.

The baseband module 205, the LO 207, the transmitter 201 and the receiver 202 may be integrated on a same integrated circuit (IC) chip. The transmitter 201 and receiver 202 can sometimes be referred to as RF front-end modules (or components) or radios. In some aspects, one or more of the aforementioned components may be on separate IC chips. Similarly, other components shown in FIG. 2A may be incorporated into the same IC chip, along with the baseband module 205, the LO 207, the transmitter 201 and the receiver 202. In some aspects, the antenna 204 is incorporated into the same IC chip. With the advent of system-on-chip (SOC) integration, host devices, application processors and/or user interfaces, such as the host 210, may be integrated into the same IC chip along with the baseband module 205, the transmitter 201 and the receiver 202.

Any of the various embodiments of the wireless communication portion 200 that may be implemented within various communication systems can incorporate functionality to perform communication via more than one standard, protocol, or other predetermined means of communication. For example, the wireless communication portion 200 implemented as a single communication device, can include functionality to perform communication in accordance with a first protocol, a second protocol, and/or a third protocol. These various protocols may be WiMAX (Worldwide Interoperability for Microwave Access) protocol, a protocol that complies with a wireless local area network (e.g., WLAN/WiFi) (e.g., one of the IEEE (Institute of Electrical and Electronics Engineer) 802.11 protocols such as 802.11a, 802.11b, 802.11g, 802.11n, 802.11ac or 802.11ax), a Bluetooth protocol, or any other predetermined means by which wireless communication may be effectuated.

FIG. 2B is a diagram illustrating a wireless communication device 250 of a wireless device having multiple antennas according to one or more implementations of the subject technology. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

The wireless communication device 250 includes firmware module 220, hardware module 230, front end module 240, and antennas 204-1, 204-2. The hardware module 230 includes a first hardware core 232-1 and a second hardware core 232-2. The first hardware core 232-1 includes a BT hardware media access control (MAC) module 234-1, a modem 236-1 and a radio 238-1. The second hardware core 232-2 includes a BT hardware MAC module 234-2, a modem 236-2 and a radio 238-2. As depicted in FIG. 2B, each of the modems 234-1 and 234-2 include a respective channel quality module. The firmware module 220 includes a central processing unit (CPU) 222. The CPU 222 includes a transmit path module 224, a receive path module 226, and a channel quality assessment module 228.

In some implementations, separate antennas are used for each hardware core to facilitate Bluetooth packet transmit optimization with simultaneous channel sensing. For example, the first hardware core 232-1 and the second hardware core 232-2 are coupled to the antenna 204-1 and the antenna 204-2, respectively, via the front end module 240. In some implementations, the antennas 204-1 and 204-2 are utilized with the wireless communication portion 200 to provide antenna diversity or multiple input and/or multiple output (MIMO) capabilities.

Outbound data for transmission from the transmit path module 222 is forwarded to the BT hardware MAC module 234-1 and converted into baseband signals, then upconverted for transmission by the modem 236-1, and transmitted by the radio 238-1 via the front end module 240. For example, the modem 236-1 may convert the baseband signals to outbound radio frequency (RF) signals for transmission from the first hardware core 232-1 via the antenna 204-1. The modem 236-1 may utilize one of a variety of up-conversion or modulation techniques to convert the outbound baseband signals to outbound RF signals.

Inbound RF signals are received by the antenna 204-1 and coupled to the first hardware core 232-1. The modem 236-1 then converts the inbound RF signals into inbound baseband signals, which are then coupled to the receive path module 226. The modem 236-1 may utilize one of a variety of down-conversion or demodulation techniques to convert the inbound RF signals into inbound baseband signals. In a similar manner, inbound RF signals are also received by the antenna 204-2 and coupled to the second hardware core 232-2. The modem 236-2 then converts the inbound RF signals into inbound baseband signals, which are then coupled to the channel quality assessment module 228.

In some implementations, the channel quality module of each of the modem 236-1 and the modem 236-2 may perform channel quality sensing of one or more channels (or frequencies) by obtaining signal strength measurements from the inbound RF signals. In some implementations, the channel quality module of the second hardware core 232-2 is operable to perform channel sensing simultaneously with the reception of a packet (e.g., slave-to-master packet) by the first hardware core 232-1. In this respect, packet transmission optimization can be achieved by allowing channel sensing to occur and performing a remedial action prior to transmission of a packet based on results of the channel sensing. As depicted in FIG. 2B, the channel quality assessment module 228 can receive the signal strength measurements (e.g., RSSI) and assess the measurements by comparing them to a predetermined threshold for determining whether a remedial action should be performed and the type of remedial action to perform. If the channel conditions appear satisfactory, the packet is transmitted on the sensed channel in the originally scheduled time slot without application of a remedial action. Otherwise, a remedial action may be performed that defers the transmission of the packet to a different channel and/or timeslot, increases the transmission power and/or modifies the packet length or type of the packet.

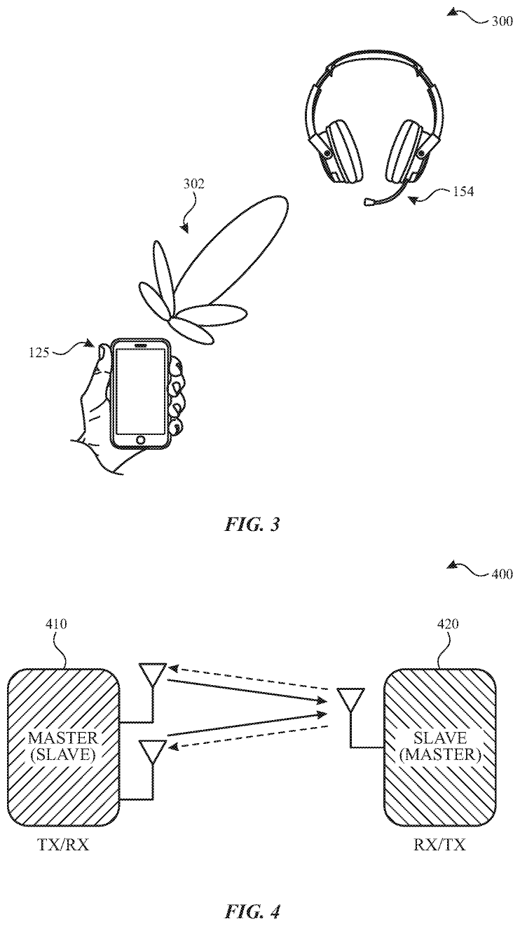

FIG. 3 conceptually illustrates an example of a communication environment 300 according to one or more implementations of the subject technology. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

In some aspects, a dual-core BT chip (or a scan core chip) can provide beamforming/combining capabilities that are utilized to direct a beam to concentrate the transmitted energy. As depicted in FIG. 3, when wireless communication devices, such as the cellular telephone 125 and the BT device 154 communicate in the communication environment 300, a directed beam 302 may be directed by the cellular telephone 125 toward the BT device 154. In some aspects, the BT device 154 may be a wireless headset. The illustration of FIG. 3 shows a plurality of directed energy lobes emanating from the cellular telephone 125, in which one lobe is larger than the other to indicate the directed energy in a particular orientation. Accordingly, in FIG. 3, the larger lobe represents the orienting of the directional antennas for a first wireless device to communicate with a second wireless device optimally. Although a transmitting device (e.g., 125) can orient the antenna to transmit a directed energy beam to a receiving BT device (e.g., 154), the transmitting device can facilitate in sensing the quality of a next upcoming channel such that a remedial action can be performed before initiating transmission of a packet based on the sensed channel measurements.

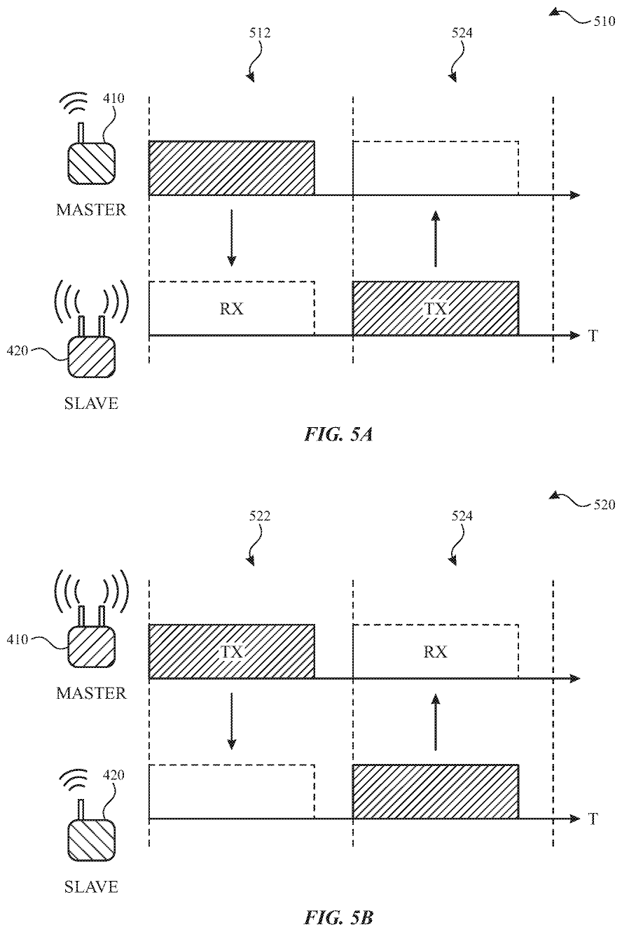

FIG. 4 illustrates an example of a Bluetooth communication system 400 according to one or more implementations of the subject technology. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

The Bluetooth communication system 400 includes a master device 410 and a slave device 420. The Bluetooth communication system 400 may be operable to utilize a frequency division multiple access (FDMA) scheme and a time division multiple access (TDMA) scheme to support vice and/or data communication. In some implementations, the Bluetooth communication system 400 may be enabled to utilize a TDMA based polling scheme in link layer communications between the master device 410 and the slave device 420. In this regard, the TDMA based polling scheme involves one device (e.g., master device 250) transmitting a packet at a predetermined time and a corresponding device (e.g., slave device 260) responding with a packet after a predetermined time.

As depicted in FIG. 4, the master device 410 includes multiple antennas or an antenna arrays to create spatial diversity over the communication channel with the slave device 420. For example, the master device 410 can send a same signal from each transmit antenna, in which the phase of each signal is adjusted in such a way that the phases are added constructively at the slave device 420. Within a connection event, the master and slave devices alternate sending data packets using the same data channel. In some implementations, the master device 410 initiates the beginning of each connection event and can end each connection event at any time.

In some implementations, the master device 410 sends a data packet during one or more timeslots over a first frequency to the slave device 420. In a timeslot immediately subsequent to the one or more timeslots, the master device 410 can measure the signal quality of a second frequency that may be a consecutive channel from the first frequency. This scan performed by the master device 410 may occur concurrently with the slave device 420 sending an acknowledgement signal to the master device 410. Depending on the signal quality measured by the master device 410, the master device 410 may perform one or more remedial actions in a subsequent timeslot.

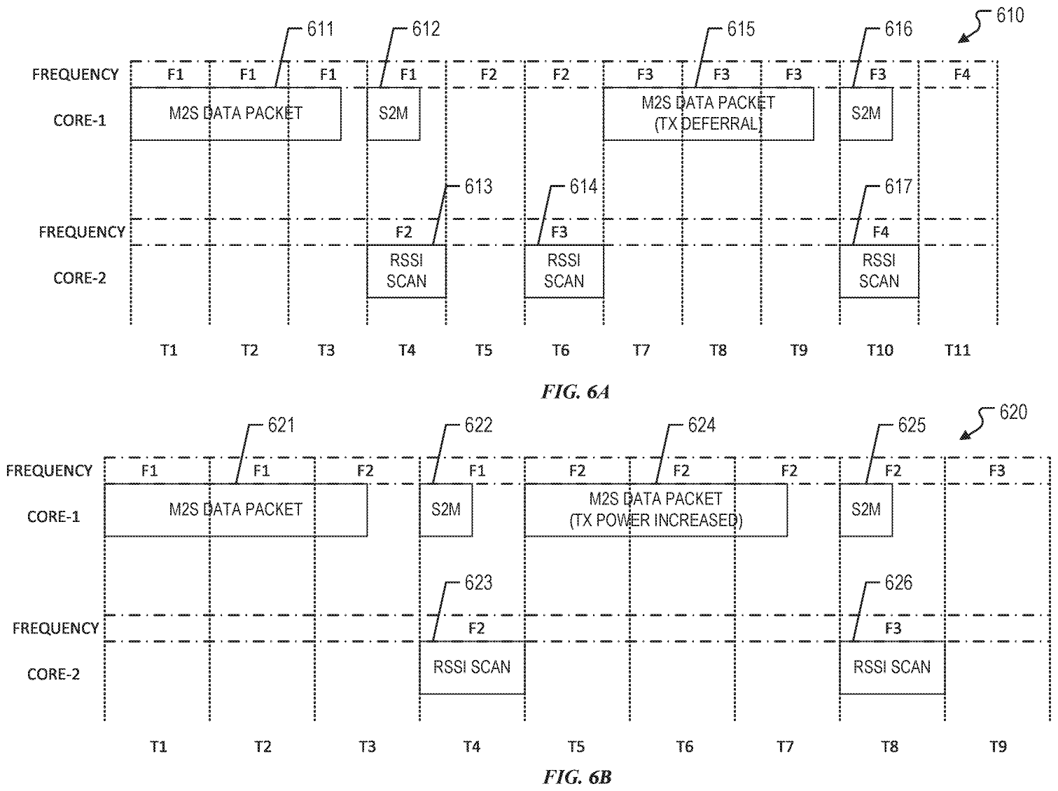

FIGS. 5A and 5B illustrate examples of a frame exchange between a master device and a slave device according to one or more implementations of the subject technology. During a connection event, data packets may be transmitted with inter-frame spacing and at least one data packet may originate from a master such as the master device 410 in the connection event. The master device 410 may transmit the first data packet in each connection event to an intended slave such as the slave device 420. In this regard, the slave device 420 may transmit a response after a predetermined time (e.g., 514), which can then be followed by another master transmit (not shown). The master device 410 may be operable to utilize a TDMA based polling scheme to poll the intended slave for packet transmission in each connection event. The master device 410 may be enabled to determine packet payload size for data packets and packet transmission timing in each connection event.

The slave device 420 may be associated with one or more link layer connections with the master device 410. The slave device 420 may be enabled to synchronize with connection event start points, called anchor points from a perspective of the slave device 420, for data communication with the master device 410. The slave device 420 may consider that a link layer connection setup with the master device 410 may be complete after receiving a connection request packet from the master device 410. The slave device 420 may be operable to transmit data packets in the data channel after receiving a packet from the master device 410 in the associated link layer connection.

In FIG. 5A, a first frame exchange 510 includes a master device (e.g., 410) with a single antenna transmitting first to a slave device (e.g., 420) in a first time slot 512. In this respect, the slave device 420, having multiple antennas, receives first and transmits second. During a second time slot 514, the master device 410 may be operable to perform a signal quality scan (e.g., received signal strength indicator (RSSI) scan) on a different channel (e.g., a next channel) from that being used to carry the packet exchange between the master device 410 and the slave device 420. The master device 410 may decide to perform a particular remedial action during a subsequent time (not shown) based on the RSSI scan. For example, the master device 410 may decide to defer transmission of a data packet to the slave device 420 on the measured channel during a subsequent time slot based on a relatively high RSSI measurement on the next channel. In another example, the master device 410 may decide to increase the transmission power of the data packet to mitigate any effects of the existing congestion measured on the next channel. In still another example, the master device 410 may decide to modify the format of the data packet, which may include modifying a packet type or a packet length depending on the bandwidth availability on the next channel.

In FIG. 5B, a second frame exchange 520 includes the master device 410 with multiple antennas transmitting first to the slave device 420 in a first time slot 522. Similarly to FIG. 5A, the master device 410 may perform a signal quality scan on a next frequency channel during a second time slot 524, and the master device 410 may decide which remedial action to perform based on the signal quality scan.

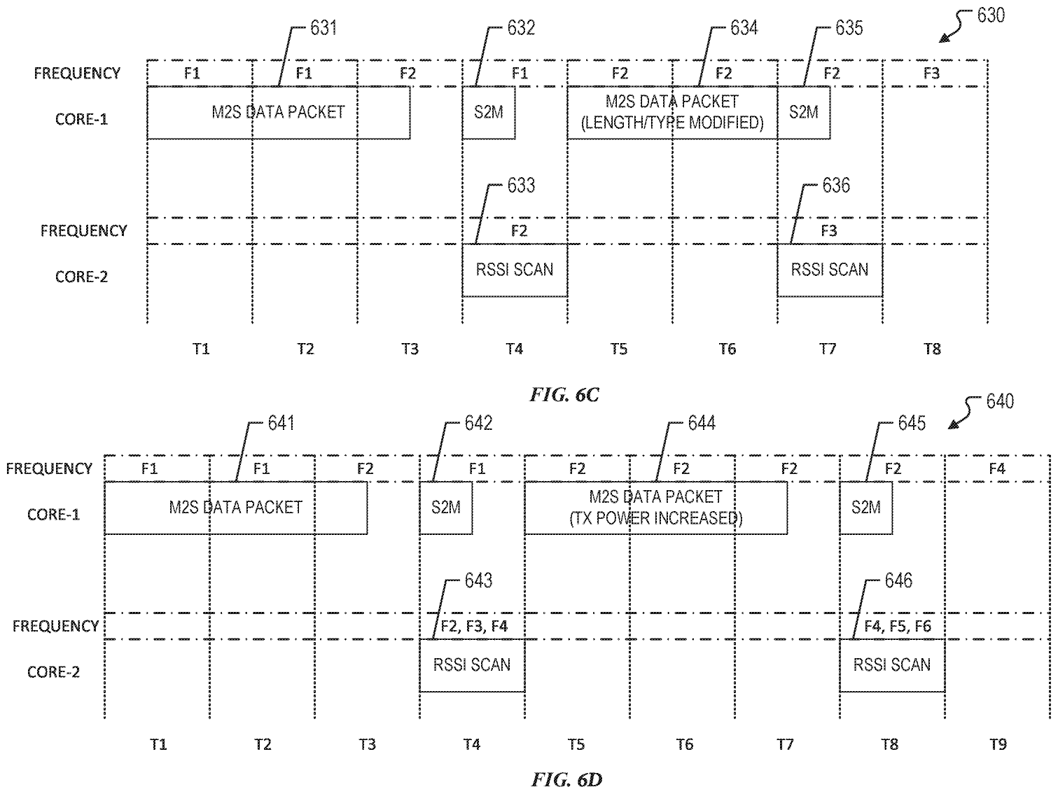

FIGS. 6A-6C illustrate diagrams of frame exchanges between master and slave devices using channel sensing simultaneous with performing different remedial actions for packet transmit optimization according to one or more implementations of the subject technology. The subject technology defines an additional step of sensing the quality of a next upcoming channel before initiating transmission of a packet. The subject technology uses channel quality metrics related to the AFH algorithm, e.g., RSSI, etc. When a measured instantaneous channel quality is assessed to be poor, the subject system utilizes some of the following potential remedial actions, such as 1) deferring transmission of a next Bluetooth frame (see FIG. 6A); 2) increasing the packet transmission power (see FIG. 6B), and/or 3) modifying a transmission packet type (See FIG. 6C). In this respect, the remedial action is an action that modifies one or more properties of a next Bluetooth frame transmission. In some implementations, the subject system may select one or more of the aforementioned remedial actions based on results of the channel sensing. In some implementations, the master device can scan multiple channels in a timeslot for deciding the best upcoming channel to use. In some aspects, the multi-channel scan can help decide the optimal transmission strategy, such as by deciding between increasing the transmission power or deferring the transmission on another channel.

FIG. 6A illustrates a frame exchange 610 between master and slave devices, in which the master device (e.g., 410) performs a first remedial action before initiating transmission of a packet on the sensed channel. In the frame exchange 610, the master device 410 initiates transmission of a first master-to-slave (M₂S) packet 611 that traverses a first frequency channel (e.g., F1) during timeslots t₁, t₂ and t₃. In some aspects, the master device 410 has multiple cores, where a first core can perform the packet transmission while a second core can perform the channel sensing. In other aspects, the master device 410 includes a single core that can perform both the packet transmission and channel sensing at different times. In this example, the first core initiates the packet transmission at timeslot t₁ and completes transmission of the packet during timeslot t₃. During timeslot t₄, the first core of the master device 410 receives a slave-to-master (S2M) response packet 612 that is transmitted by the slave device 420.

In one or more implementations, the second core of the master device 412 initiates the channel sensing on a next channel during the timeslot corresponding to the S2M response slot, namely a second frequency channel (e.g., F2). The second core of the master device 410 may initiate an RSSI scan 623 to measure the signal strength of any traffic existing on the second frequency channel. In some implementations, the second core of the master device 410 may initiate the channel sensing immediately after the transmission of the packet was completed (e.g., during a tail-end portion of timeslot t₃). In other implementations, the second core of the master device 410 may initiate the channel sensing during one or more of the transmission timeslots (e.g., t₁, t₂, t₃) if the transmission power of the first M₂S packet 611 is sufficiently low not to cause interference with the channel sensing. This may be determined by a comparison of the transmission power to a predetermined threshold.

As illustrated in FIG. 6A, the master device 410 performs a remedial action based on the results of the channel sensing. In this example, the master device 410 selected a remedial action that defers transmission of the packet by skipping transmission of a packet on the second frequency channel (e.g., F2) during an originally scheduled time period, namely timeslot t₅. In this respect, the RSSI scan 613 performed by the second core of the master device 410 revealed that a relatively high RSSI measurement on the second frequency channel is likely to congest or collide with any packet that is transmitted by the first core of the master device 410 on the second frequency channel. In a subsequent timeslot (e.g., t₆), the second core of the master device performs another channel sensing (e.g., RSSI scan 614) on the next channel, namely a third frequency channel (e.g., F3) to determine whether a transmission of a packet can be performed on that channel. The RSSI scan 614 includes RSSI measurements on the third frequency channel taken by the second core of the master device 410, which reveal that transmission of a packet is allowed due to any minimal congestion effects on that channel. The first core of the master device 410 initiates transmission of a second packet 615 at timeslot t₇, and completes the transmission during timeslot t₉. Subsequently, the second core of the master device 410 initiates another channel sensing (e.g., RSSI scan 617) on a fourth frequency channel that occurs during the same timeslot of the slave-to-master response packet 616.

FIG. 6B illustrates a frame exchange 620 between master and slave devices, in which the master device (e.g., 410) performs a second remedial action before initiating transmission of a packet on the sensed channel. In the frame exchange 620, the master device 410 initiates transmission of a first M₂S packet 621 that traverses a first frequency channel (e.g., F1) during timeslots t₁, t₂ and t₃. As illustrated in FIG. 6B, the first core initiates the packet transmission at timeslot t₁ and completes transmission of the packet during timeslot t₃. During timeslot t₄, the first core of the master device 410 receives a slave-to-master (S2M) response packet 622 that is transmitted by the slave device 420.

In one or more implementations, the second core of the master device 412 initiates the channel sensing on a next channel during the timeslot corresponding to the S2M response slot, namely a second frequency channel (e.g., F2). The second core of the master device 410 may initiate an RSSI scan 623 to measure the signal strength of any traffic existing on the second frequency channel.

The master device 410 performs a remedial action based on the results of the channel sensing. In this example, the master device 410 increases the packet transmission power as the remedial action if the RSSI scan 623 reveals that the signal strength of any congestion existing on the sensed channel, namely F2, are not high enough to interfere with the higher-powered transmission. As such, the master device 410 initiates transmission of a second M₂S packet 624 that traverses the second frequency channel (e.g., F2) during timeslots t₅, t₆ and t₇. In a subsequent timeslot (e.g., t₈), the second core of the master device performs another channel sensing (e.g., RSSI scan 626) on the next channel, namely a third frequency channel (e.g., F3) that occurs during the same timeslot of the slave-to-master response packet 625, for determining whether another packet transmission can occur during the timeslot t₉ on the third frequency channel.

FIG. 6C illustrates a frame exchange 630 between master and slave devices, in which the master device (e.g., 410) performs a third remedial action before initiating transmission of a packet on the sensed channel. In the frame exchange 630, the master device 410 initiates transmission of a first M₂S packet 631 that traverses a first frequency channel (e.g., F1) during timeslots t₁, t₂ and t₃. As illustrated in FIG. 6C, the first core initiates the packet transmission at timeslot t₁ and completes transmission of the packet during timeslot t₃. During timeslot t₄, the first core of the master device 410 receives a slave-to-master (S2M) response packet 632 that is transmitted by the slave device 420.

In one or more implementations, the second core of the master device 412 initiates the channel sensing on a next channel during the timeslot corresponding to the S2M response slot, namely a second frequency channel (e.g., F2). The second core of the master device 410 may initiate an RSSI scan 633 to measure the signal strength of any traffic existing on the second frequency channel.

The master device 410 performs a remedial action based on the results of the channel sensing. In this example, the master device 410 modifies a transmission packet type and/or packet length as the remedial action to afford sufficient bandwidth if the RSSI scan 633 reveals moderate congestion levels on the sensed channel. In one example, the master device 410 may reduce the packet length of the M₂S packet to afford additional bandwidth on the sensed channel. As illustrated in FIG. 6C, the length of the second M₂S packet 634 is reduced from a first length that extends into a portion of the timeslot t₇ to a second length that extends up to the tail end of the timeslot t₆, for example. In another example, the master device may modify the type of packet for the M₂S packet to improve the bandwidth requirements of the packet over the sensed channel. In still another packet, the master device 410 may alter the packet type and reduce the length of the packet for transmission over the sensed channel. As such, the master device 410 initiates transmission of the second M₂S packet 634 having the modified packet type and/or packet length, which traverses the second frequency channel (e.g., F2) during timeslots t₅, t₆ and t₇. In a subsequent timeslot (e.g., t₈), the second core of the master device performs another channel sensing (e.g., RSSI scan 636) on the next channel, namely a third frequency channel (e.g., F3) that occurs during the same timeslot of the slave-to-master response packet 635, for determining whether another packet transmission can occur during the timeslot t₉ on the third frequency channel.

FIG. 6D illustrates a frame exchange 640 between master and slave devices, in which the master device (e.g., 410) initiates channel sensing concurrently on multiple channels before initiating transmission of a packet on the sensed channel. In this respect, an RSSI scan can occur concurrently on multiple channels via multiple antennas of the master device 410.

In the frame exchange 640, the master device 410 initiates transmission of a first M₂S packet 641 that traverses a first frequency channel (e.g., F1) during timeslot t₁. During timeslot t₂, the first core of the master device 410 receives a slave-to-master (S2M) response packet 642 that is transmitted by the slave device 420.

In one or more implementations, the second core of the master device 412 initiates the channel sensing on multiple channels concurrently, namely frequency channels F2, F3 and F4, during the timeslot corresponding to the S2M response slot. The second core of the master device 410 may initiate an RSSI scan 643 to measure the signal strength of any traffic existing on the frequency channels. In this respect, the second core of the master device may determine that the second frequency channel (F2) would be the best channel among the sensed channels to use.

The master device 410 may perform a remedial action based on the results of the channel sensing. In this example, the master device 410 may modify the transmission power and/or the packet type as the remedial action. As such, the master device 410 initiates transmission of the second M₂S packet 644, which traverses the second frequency channel (e.g., F2) during timeslots t₃, t₄ and t₅. In a subsequent timeslot (e.g., t₆), the second core of the master device performs another channel sensing (e.g., RSSI scan 646) on the next channel, namely frequency channels F4, F5 and F6, which occurs during the same timeslot of the slave-to-master response packet 645, for determining whether another packet transmission can occur during the timeslot on the third frequency channel. The second core of the master device determines that the fourth frequency channel (F4) has suboptimal channel conditions, thereby causing the second core to select transmission deferral as the remedial action during the timeslot t₇.

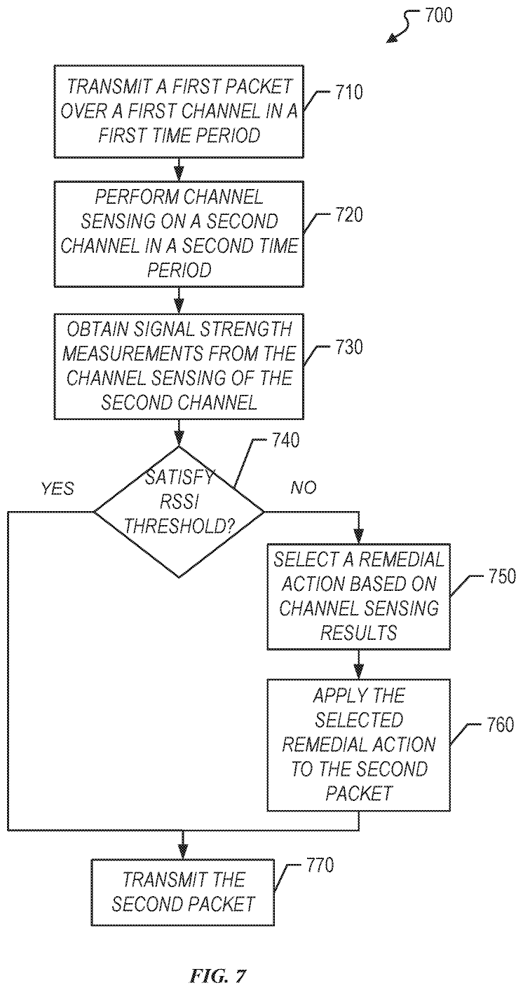

FIG. 7 is a flow chart illustrating a process 700 for packet transmit optimization with simultaneous channel sensing in accordance with one or more implementations of the subject technology. For explanatory purposes, the example process 700 is primarily described herein with reference to the wireless communication portion 200 of FIG. 2; however, the example processes 700 is not limited to the wireless communication portion 200 of FIG. 2, and one or more blocks (or operations) of the process 700 may be performed by one or more other components or circuits of wireless communication portion 200, such as the transmitter 201. Further for explanatory purposes, the blocks of the example process 700 are described herein as occurring in serial, or linearly. However, multiple blocks of the example process 700 can occur in parallel. In addition, the blocks of the example process 700 can be performed in a different order than the order shown and/or one or more of the blocks of the example process 700 are not performed.

The process 700 begins at step 710, where a master Bluetooth device (e.g., 410) transmits a first packet over a first channel in a first time period. Next, at step 720, the master device performs channel sensing on a second channel in a second time period. The second channel may be consecutive to the first channel in some implementations, or may be a different channel of an arbitrary order from the first channel in other implementations.

Subsequently, at step 730, the master device obtains signal strength measurements from the channel sensing of the second channel. In this respect, the master device may obtain RSSI measurements that indicate the signal strength of any frames traversing the second channel at the time of the channel sensing.

If the signal strength measurements satisfy a particular threshold that allows for transmission of a packet over the sensed channel, then the process 700 proceeds to step 770. Otherwise, the process 700 proceeds to step 750, where the master device can select a remedial action prior to transmission of the packet. In some examples, the master device may determine that the signal strength measurement significantly exceeds an RSSI threshold such that transmission of a packet on the sensed channel may not desirable. In this respect, a remedial action that defers transmission of the packet on the sensed channel may be selected by the master device. In other examples, the master device may determine that the signal strength measurement indicates traffic congestion when compared to the RSSI threshold, such that a remedial action that increases the transmission power of a packet to mitigate effects of the congestion can be selected by the master device. In still other examples, the master device may determine that the signal strength measurement indicates bandwidth limitations of the sensed channel when compared to the RSSI threshold, such that a remedial action that changes either the packet type or packet length of a packet to support the bandwidth limitations can be selected by the master device.

Next, at step 750, the master device selects a respective remedial action among the multiple remedial actions available for operation, based on the channel sensing results. In some implementations, the master device may select deferring transmission of the second packet time to a subsequent time period if the channel sensing results reveal high congestion on the sensed channel. In one or more implementations, the master device may select increasing the packet transmission power if the channel sensing results reveal that the signal strength of any congestion existing on the sensed channel are not high enough to interfere with the higher-powered transmission. In one or more implementations, the master device may select modifying the packet type and/or packet length to afford sufficient bandwidth if the channel sensing results reveal moderate congestion levels on the sensed channel. Subsequently, at step 760, the master device applies the selected remedial action to a transmission of a second packet. Next, at step 770, the master device transmits the second packet to a slave Bluetooth device (e.g., 420).

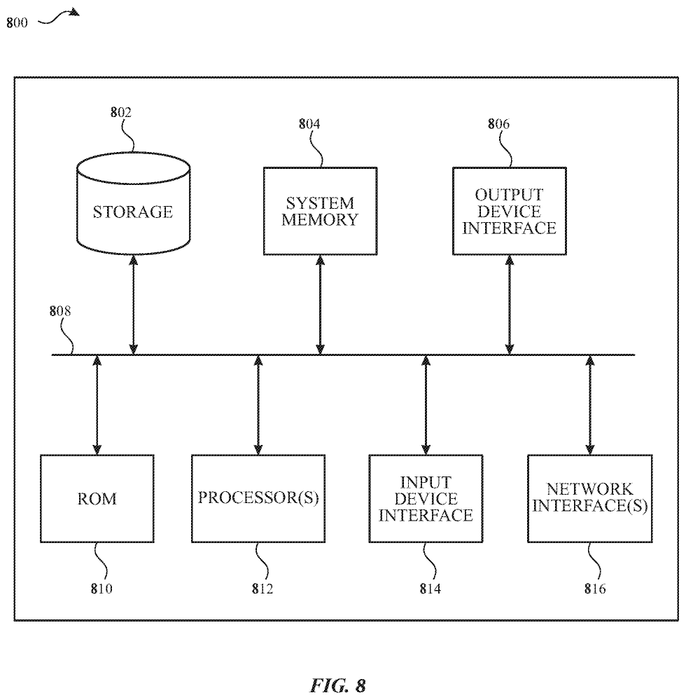

FIG. 8 conceptually illustrates an electronic system 800 with which one or more implementations of the subject technology may be implemented. The electronic system 800, for example, can be a network device, a media converter, a desktop computer, a laptop computer, a tablet computer, a server, a switch, a router, a base station, a receiver, a phone, or generally any electronic device that transmits signals over a network. Such an electronic system 800 includes various types of computer readable media and interfaces for various other types of computer readable media. In one or more implementations, the electronic system 800 is, or includes, one or more of the wireless communication devices 80-127 and BT devices 150-159. The electronic system 800 includes a bus 808, one or more processing unit(s) 812, a system memory 804, a read-only memory (ROM) 810, a permanent storage device 802, an input device interface 814, an output device interface 806, and a network interface 816, or subsets and variations thereof.

The bus 808 collectively represents all system, peripheral, and chipset buses that communicatively connect the numerous internal devices of the electronic system 800. In one or more implementations, the bus 808 communicatively connects the one or more processing unit(s) 812 with the ROM 810, the system memory 804, and the permanent storage device 802. From these various memory units, the one or more processing unit(s) 812 retrieves instructions to execute and data to process in order to execute the processes of the subject disclosure. The one or more processing unit(s) 812 can be a single processor or a multi-core processor in different implementations.

The ROM 810 stores static data and instructions that are needed by the one or more processing unit(s) 812 and other modules of the electronic system. The permanent storage device 802, on the other hand, is a read-and-write memory device. The permanent storage device 802 is a non-volatile memory unit that stores instructions and data even when the electronic system 800 is off. One or more implementations of the subject disclosure use a mass-storage device (such as a magnetic or optical disk and its corresponding disk drive) as the permanent storage device 802.

Other implementations use a removable storage device (such as a floppy disk, flash drive, and its corresponding disk drive) as the permanent storage device 802. Like the permanent storage device 802, the system memory 804 is a read-and-write memory device. However, unlike the permanent storage device 802, the system memory 804 is a volatile read-and-write memory, such as random access memory. System memory 804 stores any of the instructions and data that the one or more processing unit(s) 812 needs at runtime. In one or more implementations, the processes of the subject disclosure are stored in the system memory 804, the permanent storage device 802, and/or the ROM 810. From these various memory units, the one or more processing unit(s) 812 retrieves instructions to execute and data to process in order to execute the processes of one or more implementations.

The bus 808 also connects to the input device interface 814 and the output device interface 806. The input device interface 814 enables a user to communicate information and select commands to the electronic system. Input devices used with the input device interface 814 include, for example, alphanumeric keyboards and pointing devices (also called “cursor control devices”). The output device interface 806 enables, for example, the display of images generated by the electronic system 800. Output devices used with the output device interface 806 include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 8, the bus 808 also couples the electronic system 800 to one or more networks (not shown) through one or more network interfaces 816. In this manner, the computer can be a part of one or more network of computers (such as a local area network (“LAN”), a wide area network (“WAN”), or an Intranet, or a network of networks, such as the Internet. Any or all components of the electronic system 800 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In some implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as application specific integrated circuits (ASICs) or field programmable gate arrays (FPGAs). In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (e.g., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
transmitting, by a first device, a first packet over a first channel in a first time period;
performing, by the first device, channel sensing on a second channel in a second time period;
obtaining, by the first device, signal strength measurements from the channel sensing of the second channel;
determining, by the first device, whether the signal strength measurements satisfy a predetermined threshold;
selecting, by the first device, at least one remedial action of a plurality of remedial actions when the signal strength measurements do not satisfy the predetermined threshold;
applying, by the first device, the at least one remedial action to a second packet, the at least one remedial action modifying one or more properties of a transmission of the second packet; and
transmitting, by the first device, the second packet to a second device, following the applied at least one remedial action.

2. The method of claim 1, wherein applying the at least one remedial action comprises deferring the transmission of the second packet from an originally scheduled time period to a third time period subsequent to the second time period.

3. The method of claim 1, wherein applying the at least one remedial action comprises increasing power to the transmission of the second packet.

4. The method of claim 1, wherein applying the at least one remedial action comprises modifying a packet type of the second packet.

5. The method of claim 1, wherein applying the at least one remedial action comprises modifying a packet length of the second packet.

6. The method of claim 1, wherein performing the channel sensing comprises performing the channel sensing on a plurality of channels concurrently.

7. The method of claim 1, wherein the channel sensing is performed by a first processing core, and one or more of the first packet or the second packet is transmitted by a second processing core separate from the first processing core.

8. The method of claim 1, wherein the channel sensing is performed during a timeslot that corresponds to a concurrent response packet from a second device.

9. The method of claim 1, wherein the channel sensing is performed immediately following transmission of the first packet during a same timeslot as the transmission.

10. The method of claim 1, wherein the channel sensing is performed concurrently with transmission of the first packet if power of the transmission is less than a predetermined threshold.

11. A device comprising:
at least one processor configured to:
provide, for transmission, a first packet over a first channel in a first time period;
perform channel sensing on a second channel in a second time period subsequent to the first time period;
apply a remedial action to a transmission of a second packet based on the channel sensing; and
provide, for transmission, the second packet following the applied remedial action.

12. The device of claim 11, wherein the at least one processor is further configured to:
defer the transmission of the second packet from an originally scheduled time period to a different time period that is one or more time periods subsequent to the second time period as the remedial action.

13. The device of claim 11, wherein the at least one processor is further configured to:
increase power to the transmission of the second packet as the remedial action.

14. The device of claim 11, wherein the at least one processor is further configured to:
modify one or more of a packet type or a packet length of the second packet as the remedial action.

15. The device of claim 11, wherein the at least one processor is further configured to:
perform the channel sensing on a plurality of channels concurrently.

16. A computer program product comprising instructions stored in a tangible computer-readable storage medium, the instructions comprising:
instructions for transmitting a first packet over a first channel in a first time period;
instructions for performing channel sensing on a second channel in a second time period;
instructions for determining whether signal strength measurements from the channel sensing satisfy a predetermined threshold;
instructions for modifying a transmission of a second packet as a remedial action when the signal strength measurements do not satisfy the predetermined threshold; and
instructions for transmitting the second packet following the remedial action.

17. The computer program product of claim 16, wherein the instructions for modifying the transmission of a second packet further comprise:
instructions for deferring the transmission of the second packet from an originally scheduled time period to a different time period that is one or more time periods subsequent to the second time period.

18. The computer program product of claim 16, wherein the instructions for modifying the transmission of a second packet further comprise:
instructions for increasing power to the transmission of the second packet.

19. The computer program product of claim 16, wherein the instructions for modifying the transmission of a second packet further comprise:
instructions for modifying one or more of a packet type or a packet length of the second packet.

20. The computer program product of claim 16, wherein the instructions for performing the channel sensing further comprise:
instructions for performing the channel sensing on a plurality of channels concurrently.
